(19) United States
(12) Patent Application Publication
(10) Pub. No.: US 2007/0115786 A1
(43) Pub. Date: May 24, 2007

(54) RECORDABLE/REWRITABLE OPTICAL DISC AND ADDRESS INFORMATION RECORDING METHOD FOR THE SAME

(75) Inventors: Yuan-Ching Lai, Hsinchu (TW); Wen-Hung Lan, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp., Taipei City (TW)

(21) Appl. No.: 11/560,444

(22) Filed: Nov. 16, 2006

(30) Foreign Application Priority Data
Nov. 21, 2005 (TW) 094140838

(51) Int. Cl. G11B 20/12

(52) U.S. Cl. 369/59.25

(57) ABSTRACT

A recordable/rewritable optical disc is defined with a lead-in section, a data zone and a lead-out section. The data zone is further defined with a plurality of recording unit blocks, each of which includes a physical cluster for recording data therein and a linking area for recording therein address information linking to the data, wherein the address information of a recording unit block is further recorded in a linking area of another recording unit block.

### FIELD OF THE INVENTION

The present invention relates to a recordable/rewritable optical disc for use in an optical reading/writing apparatus. The present invention also relates to a method for recording address information into a recordable/rewritable optical disc.

### BACKGROUND OF THE INVENTION

Optical discs have been become main stream as storage media. Basically, optical discs are classified into data discs and video discs with regard to the recorded contents. CD (compact disc) and DVD (digital video disc) are two typical specifications for recording common data and video data, respectively. For either CD or DVD, they can be further classified according to functions supported thereby. For example, while CD-ROM and DVD-ROM support only reading functions, CD-R/RW, DVD+R/−R and DVD+RW/−RW, etc., support both reading and writing functions.

In recent years, DVD has been performed very well compared to conventional storage media. However, with the development of optical storage technology, even DVD is still not perfect for making use of the advanced technology. Therefore, there still are demands in developing storage media providing more recording capacity, higher image quality such as HD (High-Definition) images, and more versatile applications such as security functions. Now, BD (Blue-ray Disc) is one of the new versions of optical discs complying with more requirements than conventional storage media.

Compared with DVD, the single-face-single-layer capacity of BD is 25 GB (Gigabyte), which is much higher than DVD's 4.7 GB. This is because BD uses blue laser to perform data reading and writing, and blue laser has much shorter wavelength than red laser that is used by DVD. As known to those skilled in the art, the shorter wavelength allows the laser to be focused precisely and the clearance between tracks can be reduced so as to increase the storage density of an optical disc.

For CD-ROM or DVD-ROM, the method for recording data is performed in a continuous manner. For example, when DAO (Disc-At-Once) writing means is used for recording data, all data are recorded into the optical disc at once. That is, each data is written into the optical disc starting with a lead-in sector and ending with a lead-out sector, and all the data are continuous and relevant to each other.

CD-R/RW, DVD+R/−R, and DVD+RW/−RW, on the other hand, use a discrete method for recording data into a plurality of separate data zones. Among data zones, linking areas are provided. For example, when TAO (Track-At-Once) writing means is used for recording data, there will be buffer space remaining between tracks, which is defined with linking area, run-in section and run-out section, for recording address information. According to the address information, an optical reading/writing apparatus is able to access correct data.

As CD-ROM and DVD-ROM are published earlier than recordable/rewritable optical discs, the specifications of the latter should be compatible with CD-ROM and DVD-ROM. For achieving this purpose, the recording types and recording functions recorded in the linking area of the recordable/rewritable optical disc should be able to identify CD-ROM and DVD-ROM.

FIG. 1 is a schematic diagram depicting a data structure recorded in BD 10. The data structure of the BD 10 comprises a lead-in section 11, a data zone 12, and a lead-out section 13. The data zone 12 comprises a plurality of recording unit blocks 120, and ends with a tail section 124. In each recording unit block 120, a run-in section 121, a physical bluster 122 and a run-out section 123 are included. The run-in section 121 and the run-out section 123 function as a linking area, and the physical bluster 122 functions for recording data. Because data recorded in the data zone 12 are random and discrete, the address information of each data should be simultaneously recorded in the data zone 12 to make sure all the data can be well located by an optical reading/writing apparatus.

On a recordable/rewritable BD, a groove is provided for guiding a laser beam for writing data precisely, and a wobble structure, which is about 10 nm in size, is specifically disposed in the groove for recording ADIP (Address in Pre-groove) address information by adopting technology such as Minimum Shift Keying and Saw Tooth Wobble. Unfortunately, recording address information in the wobble structure may cause signal amplitude dropping, and thus it is difficult to detect the recorded address information.

The above-mentioned problem can be ameliorated by recording address information in a BIS code. However, the BIS code is recorded together with data in a data zone, so the address information cannot be realized until certain data is properly isolated and decoded. For example, each data zone generally consists of a plurality of clusters that are defined with identical recording frames, e.g. 1932 channel bits (cbs). Recording address information in a BIS code requires 3 clusters to be read at the same time, which will be up to 5796 cbs, in order to realize the address information precisely.

In addition, data reading may be subjected to errors due to linking errors if the area recorded therein address information is damaged or scratched, or the disc has been repetitively written several times. Therefore, it is necessary to provide a method for realizing address information efficiently and correctly so as to enhance the performance of the optical reading/writing apparatus.

### SUMMARY OF THE INVENTION

The present invention provides a recordable/rewritable optical disc and method for recording address information into the recordable/rewritable optical disc with enhanced data-reading efficiency and accuracy.

According to the present invention, a method for recording address information into a recordable/rewritable optical disc by an optical reading/writing apparatus is provided. The method includes steps of: providing a first data and a second data to be written into the recordable/rewritable optical disc by the optical reading/writing apparatus; defining a first recording unit block and a second recording unit block for storing the first data and the second data, respectively, by the optical reading/writing apparatus; and recording a first address information and a second address information linking to the first data and the second data in the first recording unit block and the second recording unit block, respectively, while recording the second address information in the first recording unit block.

In an embodiment, the first and second data are recorded in the physical clusters of the first and second recording unit block, respectively, while the first and second address information are recorded in the linking areas of the first and second recording unit blocks, respectively. For example, the first and second address information can be recorded in the run-in sections of the first and second recording unit blocks, respectively. Alternatively, the first and second address information can be recorded in the run-out sections of the first and second recording unit blocks, respectively.

In an embodiment, the recordable/rewritable optical disc includes a lead-in section, a data zone and a lead-out section, and the first and second recording unit blocks are defined in the data zone.

In an embodiment, a third data is further provided to be written into a third recording unit block defined on the recordable/rewritable optical disc by the optical reading/writing apparatus, wherein the second address information is further recorded in the third recording unit block.

In an embodiment, the first, second and third recording unit blocks are contiguous, and the first address information linking to the first data and a third address information linking to the third data are also recorded in the second recording unit block.

In an embodiment, the first and second address information are added with a check code. For example, the check code is a parity check code or an ECC code.

In an embodiment, the first address information and second address information are encoded under RLL mechanism.

The present invention also relates to a recordable/rewritable optical disc, which is defined with a lead-in section, a data zone and a lead-out section. The data zone further includes a plurality of recording unit blocks, each of which is defined with a physical cluster for recording data therein; and a linking area for recording therein address information linking to the data, wherein the address information of a recording unit block is further recorded in a linking area of another recording unit block.

In an embodiment, the linking area includes a run-in section and a run-out section respectively leading and following the physical cluster, and the address information is recorded in the run-in or run-out section.

In an embodiment, the address information of the recording unit block is further recorded in a linking area of a further recording unit block.

In an embodiment, one of the recording unit blocks records therein address information of at least two recording unit blocks. For example, one of the recording unit blocks records therein address information of three recording unit blocks including the recording unit block itself and two recording unit blocks contiguous thereto.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a data structure of a blue-ray disc;

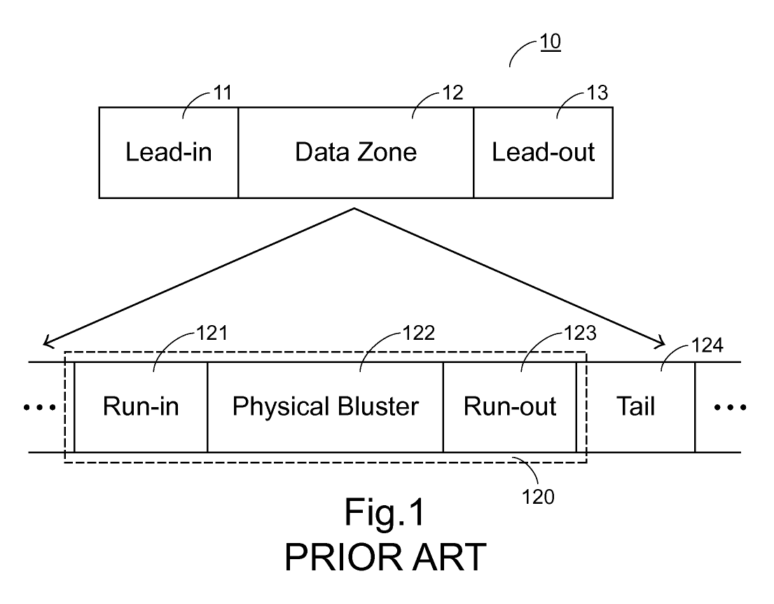

FIG. 2(a) is a schematic diagram illustrating a data structure of a recordable/rewritable disc;

FIG. 2(b) is a schematic diagram illustrating a data structure with address information shared by continuous recording unit blocks according to an embodiment of the present invention;

FIG. 2(c) is a schematic diagram illustrating a data structure with address information shared by continuous recording unit blocks according to another embodiment of the present invention; and

FIG. 3 is a flowchart illustrating a method for recording address information into an optical disc according to an embodiment of the present invention.

### DETAILED DESCRIPTION OF THE PREFERRED EMBODIMENT

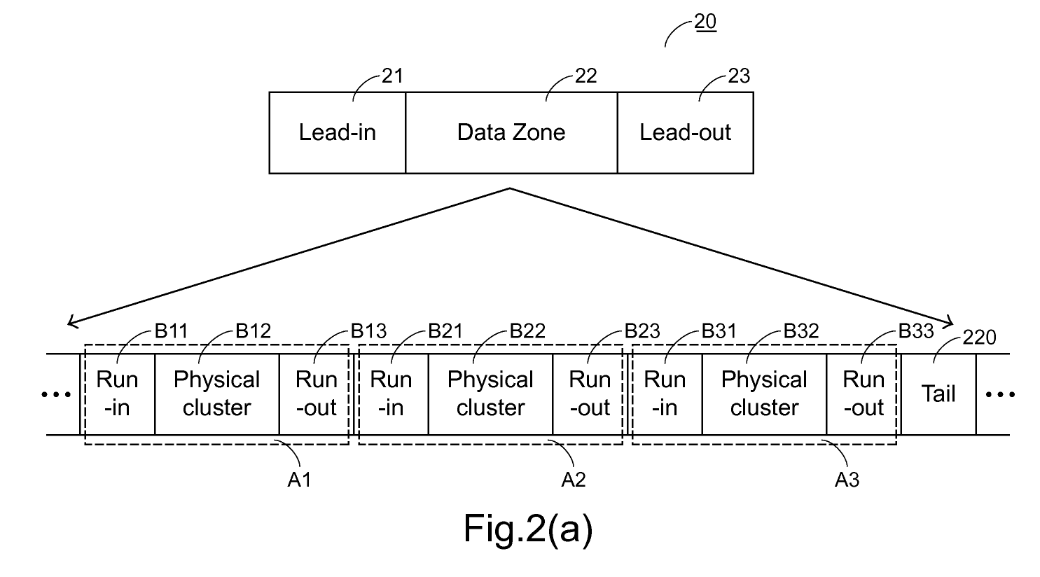

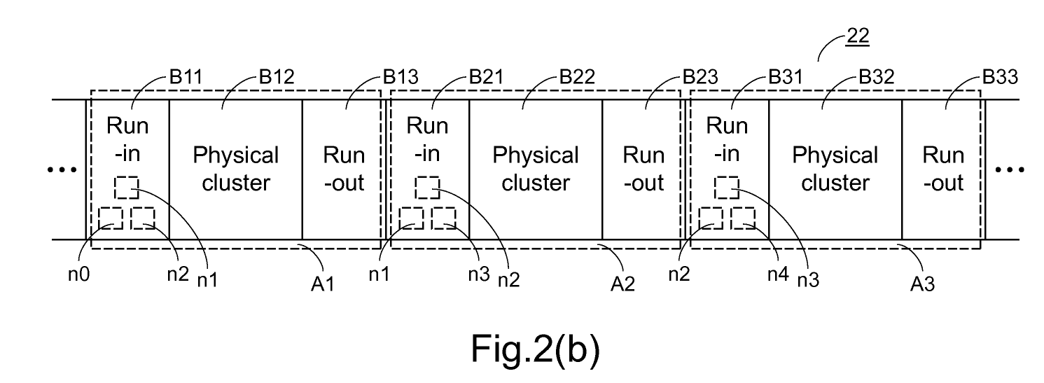

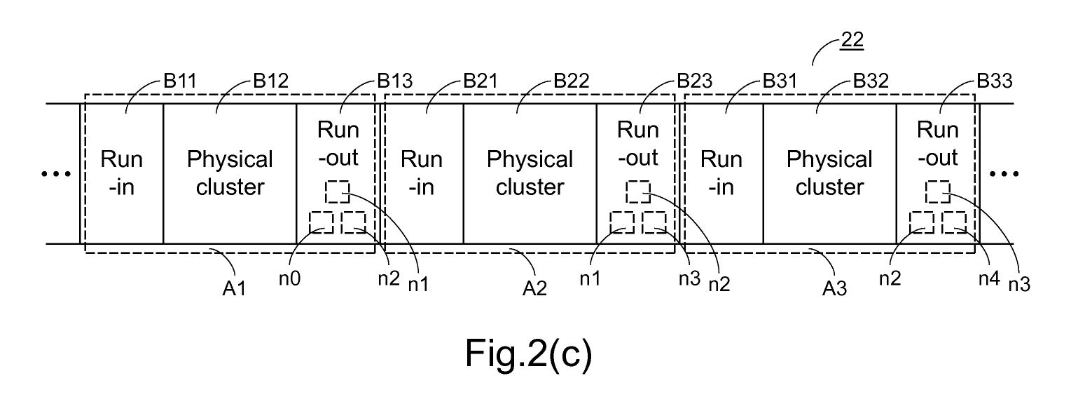

As depicted in FIG. 2(a), a high-definition-high-density recordable/rewritable blue-ray disc 20, e.g. BD-R/RW, is exemplified hereinafter to illustrate the present invention. The data recorded in the BD 20 includes a lead-in section 21, a data zone 22 and a lead-out section 23. The data zone 22 further includes a plurality of recording unit blocks A1, A2, A3, etc., and ends with a Tail section 220. The first recording unit block A1, the second recording unit block A2 and the third recording unit block A3 are three continuous recording unit blocks defined in the data zone 22 by the optical reading/writing apparatus, and each recording unit block includes a run-in section, a physical cluster and a run-out section.

For example, the first recording unit block A1 includes a run-in section B11, a physical cluster B12, and a run-out section B13; the first recording unit block A2 includes a run-in section B21, a physical cluster B22, and a run-out section B23; and the first recording unit block A3 includes a run-in section B31, a physical cluster B32, and a run-out section B33. Generally, data are recorded in the physical clusters. The run-in section and the run-out section are used as a buffer for data writing and serve as a linking area between recording unit blocks, which allows the data stored in different physical clusters to be properly linked.

When a data is recorded into the physical cluster B22 of the recording unit block A2, for example, an address information n2 for locating the recording unit block A2 is simultaneously recorded in the linking area, i.e. the Run-In section B21 in this example. Likewise, an address information n1 and an address information n3 for locating the recording unit blocks A1 and A3, respectively, are recorded in respective Run-In sections B11 and B31, as shown in FIG. 2(b).

As the address information is specific to a position (e.g. a specified sector, track or block) in the disc 20, the optical reading/writing apparatus is able to correctly link to the data stored in the physical cluster of the recording unit block according to the address information. Furthermore, as written data of a file or document might be distributed randomly and discretely, it is necessary to link data recorded in different sectors, tracks or blocks. Under this circumstance, the address information can be referred to locate the recording unit block. However, once the run-in section is damaged or suffers from a scratch, the address information might be lost so that the relevant data cannot be found.

Therefore, as illustrated in the embodiment of FIG. 2(b), address information of adjacent recording unit blocks are mutually recorded in the run-in sections of the recording unit blocks. For example, the address information nil and n3 of recording unit blocks are recorded in the run-in section B21 of the recording unit block A2 along with the address information n2; the run-in section B11 of the recording unit block A1 records therein address information n0 and n2 of adjacent recording unit blocks in addition to its own address information n1; and the run-in section B31 of the recording unit block A3 records therein address information n2 and n4 of adjacent recording unit blocks in addition to its own address information n3. In this manner, there is still address information available to be referred to link to relevant data of certain recording unit block even if the run-in section of that recording unit block is damaged and the address information of that recording unit block is unavailable.

Generally, there is some space, which is so-called as optional APC (automatic power control), reserved in the run-in section and/or run-out section so that the manufacturer may use it for storing the address information of three adjacent recording unit blocks as mentioned above.

In addition to providing a backup copy of the address information in adjacent recording unit block or blocks, the accuracy of the address information is preferably further assured.

In an embodiment, ECC (Error Correction Code) mechanism, which is usually used for data error detection by using several bits as a checking code for each codeword data, is applied hereto. With the ECC mechanism, specific algorithm operates to check whether the address information is consistent, find the possible error, and correct the error. In another embodiment, a parity check code is added to the address information. When the optical reading/writing apparatus decodes the address information but has problem in linking the address information to relevant data, the optical reading/writing apparatus will skip from decoding the relevant data. Instead, the optical reading/writing apparatus reads the address information from the run-in Section of the adjacent recording unit block to link to the relevant data.

Furthermore, RLL (Run Length Limited) coding mechanism, which is usually used for encoding data while writing, is also applied to the writing of the address information into the optical disc according to the present invention, thereby enhancing the accuracy of the address information. Generally, data are recorded as a series of logic values varying with distribution of pits and lands on an optical disc. For example, both continuous pits and lands result in logic “0”, and the change from pit to land or the change from land to pit results in logic “1”. In other words, when logic “1” continuously appears, it means the pit/land change occurs regularly. According to RLL (Run Length Limited) coding mechanism, continuous logic “1” is prohibited. In addition, the length of continuous logic “0” is confined within a specified range so as to make the data identifiable by the optical read/writing apparatus.

According to current BD specifications, each 2 KB data has a corresponding 32-bit address. In practice, data is written to a blue-ray disc with 64 KB as a basic unit, so there will be 32 entries of 32-bit address information recorded in the same cluster for each 64 KB data recording unit block. The 32 entries of address information are also referred to as 32 physical sector numbers (PSNs). Since the 32 PSNs direct to the same cluster, only one of the PSNs is recorded into the corresponding linking area as the address information of the recording unit block. Therefore, there will constantly be several logic “0” bits at both ends of the 32-bit data. In an example, 24 bits among the 32 bits are defined as the address information and 2 bits among the 24 bits are used as a parity check code for assuring of the accuracy of the address information. In an alternative example, more than 2 bits are defined as ECC code for achieving a similar purpose. Under this circumstance, the address information n2, representing the second data, will be recorded in the run-in B21 of the second recording unit block A2. A parity check code or ECC code of the address information n2 will be simultaneously recoded in run-in section B11 of the recording unit block A1 ahead of the recording unit block A2 and the run-in section B31 of the recording unit block A3 following the recording unit block A2. Accordingly, the accuracy of the backup copy of the address information can also be assured.

In the above embodiments and examples, the address information is recorded in the run-in section of a recording unit block. Alternatively, the address information of a certain recording unit block and the backup copy of address information of the preceding and following recording unit blocks can also be recorded in the run-in section of that recording unit block, as illustrated in FIG. 2(c).

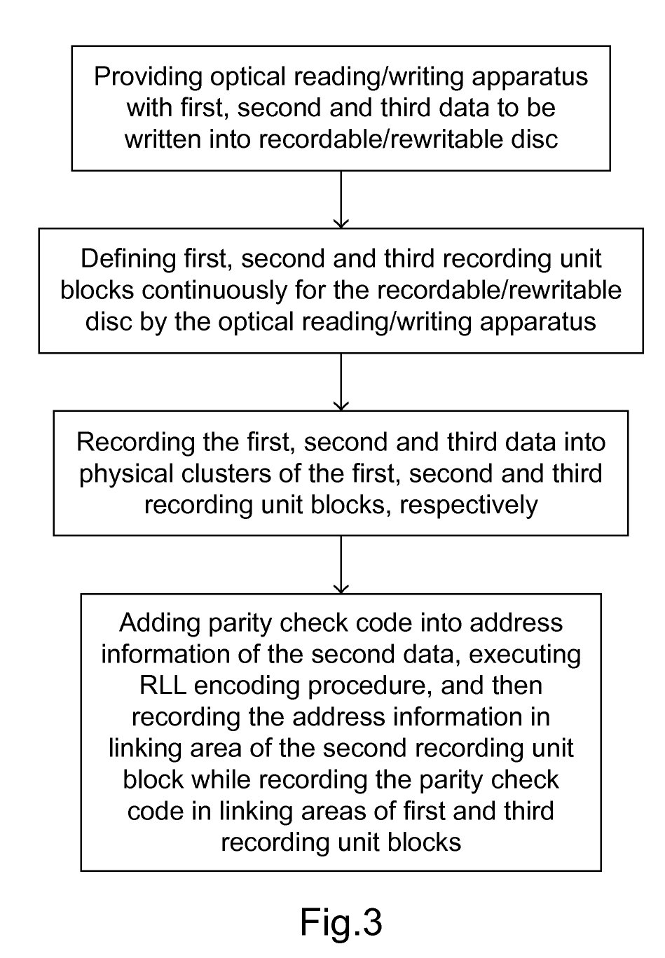

The method for recording address information into a recordable/rewritable optical disc according to an embodiment of the present invention is summarized in the flowchart of FIG. 3. When first, second and third data are to be written into an optical disc, continuous first, second and third recording unit blocks are defined in the optical disc by the optical reading/writing apparatus for recording the first, second and third data on their clusters, respectively, while recording corresponding address information in the linking areas. For example, the second address information for linking to the second data is recorded in the linking areas of the first, second and third recording unit blocks. Meanwhile, the first address information and the third address information are also recorded in the linking area of the second recording unit block. The address information is added with a parity check code or ECC code, and then encoded by RLL mechanism to be written into the linking areas in the recording unit blocks of the optical disc.

It is understood from the above descriptions that by recording the address information in the linking area, i.e. the run-in section or run-out section, instead of recording the address information along with the data in the cluster, i.e. the physical cluster, only 120 cbs of data need to be decoded for realizing the address information, which is much less than the 5796 cbs in the BIS mode. Furthermore, by recording a backup copy of address information in the preceding and/or following recording unit blocks, the desired data can be linked even if the corresponding address information cannot be successfully read due to damage, scratch or any other possible reason. Moreover, by providing parity check code or ECC code in the address information stored in the corresponding recording unit block and adjacent recording unit block(s), the correctness of the address information can be checked and optionally corrected.

The present invention is intended to cover various modifications and similar arrangements included to within the spirit and scope of the appended claims, which are to be accorded with the broadest interpretation so as to encompass all such modifications and similar structures.

What is claimed is:

1. A method for recording address information into a recordable/rewritable optical disc by an optical reading/writing apparatus, comprising the steps of:
providing a first data and a second data to be written into the recordable/rewritable optical disc by the optical reading/writing apparatus;
defining a first recording unit block and a second recording unit block for storing the first data and the second data, respectively, by the optical reading/writing apparatus; and
recording a first address information and a second address information linking to the first data and the second data in the first recording unit block and the second recording unit block, respectively, while recording the second address information in the first recording unit block.

2. The method according to claim 1 wherein the first and second data are recorded in the physical clusters of the first and second recording unit block, respectively.

3. The method according to claim 2 wherein the first and second address information are recorded in the linking areas of the first and second recording unit blocks, respectively.

4. The method according to claim 3 wherein the first and second address information are recorded in the run-in sections of the first and second recording unit blocks, respectively.

5. The method according to claim 3 wherein the first and second address information are recorded in the run-out sections of the first and second recording unit blocks, respectively.

6. The method according to claim 1 wherein the recordable/rewritable optical disc includes a lead-in section, a data zone and a lead-out section, and the first and second recording unit blocks are defined in the data zone.

7. The method according to claim 1 further providing a third data to be written into a third recording unit block defined on the recordable/rewritable optical disc by the optical reading/writing apparatus, wherein the second address information is further recorded in the third recording unit block.

8. The method according to claim 7 wherein the first, second and third recording unit blocks are contiguous.

9. The method according to claim 8 wherein the first address information linking to the first data and a third address information linking to the third data are recorded in the second recording unit block.

10. The method according to claim 1 wherein the first and second recording unit blocks are contiguous.

11. The method according to claim 1 wherein the first and second address information are added with a check code.

12. The method according to claim 11 wherein the check code is a parity check code.

13. The method according to claim 11 wherein the check code is an ECC code.

14. The method according to claim 1 wherein the first and second address information are encoded under RLL mechanism.

15. A recordable/rewritable optical disc, comprising a lead-in section, a data zone and a lead-out section, and the data zone comprising a plurality of recording unit blocks, each of which comprises:
a physical cluster for recording data therein; and
a linking area for recording therein address information linking to the data,
wherein the address information of a recording unit block is further recorded in a linking area of another recording unit block.

16. The recordable/rewritable optical disc according to claim 15 wherein the linking area includes a run-in section and a run-out section respectively leading and following the physical cluster, and the address information is recorded in the run-in section.

17. The recordable/rewritable optical disc according to claim 15 wherein the linking area includes a run-in section and a run-out section respectively leading and following the physical cluster, and the address information is recorded in the run-out section.

18. The recordable/rewritable optical disc according to claim 15 wherein the address information of the recording unit block is further recorded in a linking area of a further recording unit block.

19. The recordable/rewritable optical disc according to claim 15 wherein one of the recording unit blocks records therein address information of at least two recording unit blocks.

20. The recordable/rewritable optical disc according to claim 19 wherein one of the recording unit blocks records therein address information of two recording unit blocks contiguous thereto.
